(19) United States
(12) Patent Application Publication
(10) Pub. No.: US 2008/0172433 A1
(43) Pub. Date: Jul. 17, 2008

(54) METHOD FOR MODELING A STRUCTURE OF A SPIDER WEB USING COMPUTER PROGRAMMING

(76) Inventor: Doo Young Lee, Seoul (KR)

Correspondence Address: SCHWEITZER CORNMAN GROSS & BONDELL LLP, 292 MADISON AVENUE - 19th FLOOR, NEW YORK, NY, 10017, US

(21) Appl. No.: 11/627,506

(22) Filed: Jan. 26, 2007

(30) Foreign Application Priority Data
Jan. 12, 2007 (KR) 10-2007-0003909

(51) Int. Cl. G06F 17/10; G06F 1/02

(52) U.S. Cl. 708/276; 703/2

(57) ABSTRACT

The methods for modeling a structure of a spider web using computer programming are disclosed. First method of modeling elliptical spider webs using computer programming includes inputting variables into computer program to model spider webs; number of radii, number of spirals, length of major and minor axes of hub, length of major and minor axes of outermost ellipse, and slope of major axis. It includes calculating the functions of each radius and ellipse based on the variables. It proceeds to calculating the intersections of each radius and ellipse by using the radial and ellipse functions. It ends in modeling spider webs by connecting the intersections of each radius to draw radii and by connecting the intersections of each elliptical spiral to draw spirals, based on the intersections. The other method of modeling spiral spider webs has similar process with the notable differences in input variables, in its use of spiral functions (parametric equations), etc.

### CROSS-REFERENCE TO RELATED APPLICATIONS

This application claims all benefits of Korean Patent Application No. 10-2007-0003909 filed on Jan. 12, 2007 in the Korean Intellectual Property Office, the disclosures of which are incorporated herein by reference.

### BACKGROUND OF THE INVENTION

1. Field of the Invention

The present invention relates to method for modeling a structure of a spider web using computer programming, more particularly to method for modeling a structure of a spider web using computer programming using coordinates to mathematically analyze spider web structures, using radial functions, ellipse functions, and spiral functions (in parametric equations) to functionalize radii and spirals that form the major parts of spider webs. By applying the functions to computer modeling, the present invention uses its distinct method of modeling a structure of a spider web.

2. Background of the Related Art

Much has been known about the elasticity and stability of spider webs, and these characteristics are believed to be attributable not only to the quality of web threads but also to the geometrical structure of webs. If the practical application of web structures that withstand harsh winds and effectively distribute impacts becomes possible, various fields such as architecture, sports appliances, safety nets, etc will benefit from the present invention.

Research on the process of web building, classification of each part of the spider web structure, and study of the relationship between structures and functions have been widely conducted.

For the practical application of spider web structures, however, the mathematical analyses of spider web structures are essential, for mathematical analyses are the prerequisite for computer modeling and computer simulations of web structures. Despite the importance, relatively little research has been done on the mathematical analyses of spider webs.

In this context, a embodiment of the present invention used the induced functions that could be used to mathematically express any kind of spider webs. Then, the functions were applied to computer programming to model spider webs and utilize them.

### SUMMARY OF THE INVENTION

The present invention has been made to present a method of modeling spider web structures through mathematical analyses, using radial functions and ellipse functions or spiral functions (expressed in parametric equations) to express radii and spirals which form crucial parts of spider web structures. The present invention uses the following two methods for modeling spider web structures. The first method is as follows

First, there is provided a method of modeling elliptical spider webs using computer programming comprising: inputting 7 variables into computer program to model spider webs, including the number of radii, the number of spirals, the length of the major and minor axes of hub, the length of the major and minor axes of outermost ellipse, and the slope of the major axis (counterclockwise from X-axis); calculating the functions of each radius and the functions of each ellipse according to the number of radii and the number of spirals input based on the 7 variables; calculating the intersections (X, Y) of each radius and each ellipse by using the radial functions and ellipse functions; and modeling spider webs by connecting the intersections of each radius to draw radii and by connecting the intersections of each elliptical spiral to draw spirals, based on the intersections.

Second, there is provided a method of modeling spiral spider webs using computer programming comprising: inputting 6 variables into computer program to model spider webs, including the number of radii, the number of spirals, the winding direction of spirals, the ratio of vertical expansion, the ratio of horizontal expansion, and the angle size for rotation (counterclockwise from X-axis); calculating the functions of radii and the function of spiral (in parametric equation) according to the number of radii and the number of spirals input based on the 6 variables; calculating the intersections (X, Y) of each radius and each spiral by using the radial functions and spiral function; and modeling spider webs by connecting the intersections of each radius to draw radii and the intersections of each spiral expressed in spiral function (parametric equation) to draw spirals, based on the intersections.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram of the complete orb-web and nomenclature of the web structures;

FIG. 2 is a picture of a real spider web (Argiope minuta);

FIG. 3 is a picture of a real spider web on which the functions of radii are shown;

FIG. 4 is a diagram defining an ellipse;

FIG. 5 is a diagram of rotated ellipse;

FIG. 6 is a diagram of ellipse when its center shifts;

FIG. 7 is a diagram of real spider web on which an ellipse function is shown;

FIG. 8 is a diagram of elliptical spiral of a modeled spider web;

FIG. 9 is a diagram of elliptical spiral of a real spider web;

FIG. 10 is a diagram showing functional expressions of elliptical spiral lines that changes for every quadrant;

FIG. 11 is a picture showing the spiral part of a real web that can be expressed in spiral functions (in parametric equations);

FIG. 12 is a diagram of Archimedes Spiral;

FIG. 13 is a group diagram of spiral webs expressed in generalized spiral functions;

FIG. 14 is a group diagram of spiral webs expressed in generalized spiral functions that are rotated and whose centers are shifted;

FIG. 15 is a diagram of modeled spiral web (basic-counterclockwise) produced by connecting the intersections between the radii and spiral;

FIG. 16 is a flow chart for modeling spider webs by using radial and ellipse functions, the method of modeling spider webs according to a embodiment of the present invention;

FIG. 17 is a computer screen into which data for computer modeling of elliptical spider webs are input;

FIG. 18A to 18D show the computer modeling process of elliptical spider webs using the coordinates of intersections shown in Table 7;

FIG. 19 is a flow chart for modeling spider webs by using radial functions and spiral function (in parametric equation), the other method of modeling spider webs according to a embodiment of the present invention;

FIG. 20 is a computer screen into which data for computer modeling of spiral spider webs are input;

FIG. 21A to 21D show the computer modeling process of spiral spider webs by using the coordinates of intersections shown in Table 9;

FIG. 22 is a real spider web from which input data for computer modeling are gained;

FIG. 23 is a picture of elliptical spider web modeled by using the data gained from real spider web in FIG. 22;

FIG. 24 is a picture of spiral spider web modeled by using the data gained from real spider web in FIG. 22;

FIG. 25 is a picture of badminton racket to which computer modeled elliptical spider web will be applied;

FIG. 26 is a simulation of the elliptical spider web modeled after data from Table 12 are input into the computer program that models spider webs by using ellipse functions;

FIG. 27 is an actual application case of modeled spider web in FIG. 26 to the net of the badminton racket shown in FIG. 25;

FIG. 28 is a picture of badminton racket to which computer modeled spiral spider web will be applied;

FIG. 29 is a simulation of the spiral web modeled after data from Table 13 are input into the computer program that models spider webs by using spiral functions; and

FIG. 30 is an actual application case of modeled spider web in FIG. 29 to the net of the badminton racket shown in FIG. 28.

### DETAILED DESCRIPTION OF THE PREFERRED EMBODIMENTS

Hereinafter, preferred embodiments of the present invention will be described in detail with reference to the accompanying drawings.

As spiders' web-making skills evolved, so did the shapes of webs evolve in ways that increased prey-capturing efficiency. Except a few distinguishable characteristics, however, most orb-webs share the basic web structure.

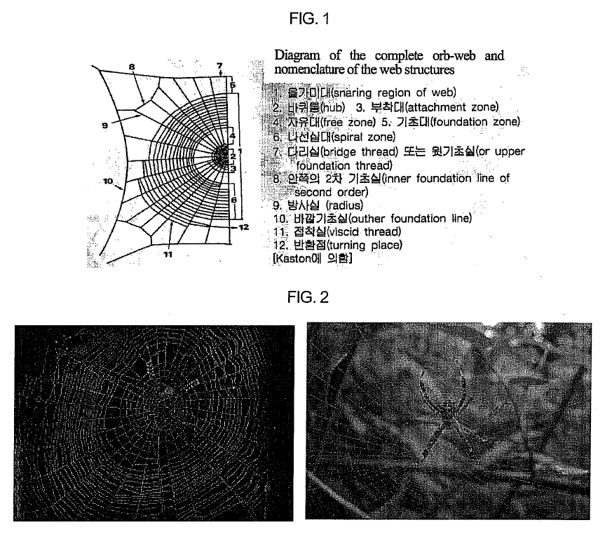

FIG. 1 is a diagram of the basic structure of an orb-web with detailed nomenclature of each part of the web structure. The nomenclature of hub, spirals, and radii, parts of web structures that are mainly used in a embodiment of the present invention is given.

In order to mathematically express actual spider webs and model them by using computer programming, the embodiment of the present invention uses photographs of real spider webs such as the photograph of web of Argiope minuta shown in FIG. 2 as data for mathematical analyses.

The method for analyzing real spider webs includes opening the file of the spider web picture on computer and marking 7 polygons from inward to outward for every spider web. On the coordinates which can indicate down to 0.1, the center of a spider web is placed on a specific point that has coordinates value of (45.4, 34.0).

Then, the coordinates of intersections of radii and spirals are read and recorded on tables. The ellipses that circumscribe each polygon are drawn to calculate the intersections between the ellipse and its major, minor, axes.

Once the intersections of each spider web are calculated, the embodiment of the present invention uses various mathematical functions and formulae such as radial function, ellipse function, spiral function (in parametric equation), and the equation for calculating the slope of ellipse, spiral, or radius. Most of the functions were induced for applications. As for statistical analyses, the embodiment of the present invention uses T-test and Regression Analysis.

By computer programming (for example, by using Visual C++) the spider webs that are expressed in radial functions and ellipse functions or spiral function (parametric equation), the embodiment of the present invention allows any kind of spider web to be modeled by inputting certain data. Once the data are input, the embodiment of the present invention uses radial and ellipse functions or radial and spiral functions (whichever are proper for the input data) to model all kinds of radii and spirals.

Hereinafter, modeling a structure of a spider web by using computer programming will be explained in detail.

1. Mathematical Expressions of Spider Webs

1) Functionalizing Radii

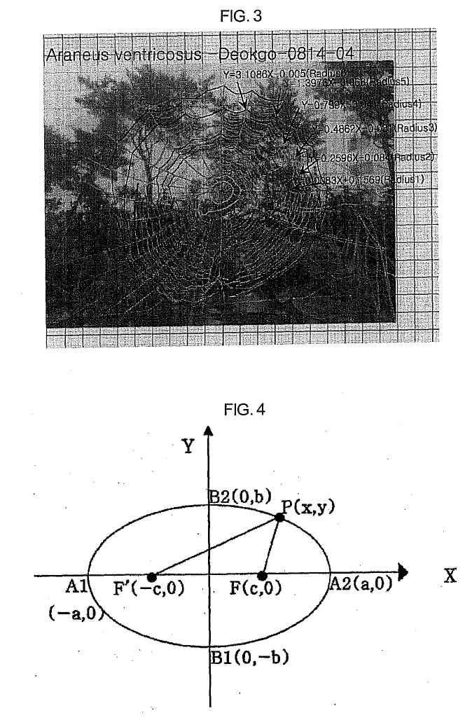

FIG. 3 is a picture of a real spider web on which the functions of radii are shown.

Referring to FIG. 3, each radius is numbered, starting from the one which is nearest to the X-axis. Then, Regression Analysis is conducted on the intersections between each radius and 7 polygons for every spider web to establish a regression line for each radius. To illustrate, regression line for radius 1 is calculated by regression analysis in a way that minimizes deviations of 7 points that make up radius 1.

Function of radius: y=αx+β,

If angle=θ, slope(α)=tan(θ)

28 radii were functionalized in the way suggested above. They are displayed in Table 1.

TABLE 1

| | | y | coefficient of | angle | angle |
|---|---|---|---|---|---|
| | slope | intercept | determination | (from | between |
| | (α) | (β) | (R²) | x-axis) | 2 radii |
| radius 1 | 0.008 | 0.157 | 0.041 | 0 | 13 |
| radius 2 | 0.260 | −0.084 | 0.902 | 14 | 14 |
| radius 3 | 0.486 | −0.081 | 0.962 | 25 | 11 |
| radius 4 | 0.799 | −0.041 | 0.979 | 38 | 13 |
| radius 5 | 1.398 | −0.068 | 0.990 | 54 | 16 |
| radius 6 | 3.109 | −0.005 | 0.998 | 72 | 18 |
| radius 7 | 18.114 | 2.175 | 0.685 | 86 | 14 |
| radius 8 | −2.295 | −0.096 | 0.967 | 113 | 27 |
| radius 9 | −1.131 | −0.179 | 0.970 | 131 | 18 |
| radius 10 | −0.471 | −0.045 | 0.969 | 154 | 23 |
| radius 11 | −0.208 | −0.057 | 0.885 | 168 | 14 |
| radius 12 | 0.027 | −0.123 | 0.072 | 181 | 13 |
| radius 13 | 0.228 | −0.174 | 0.815 | 192 | 11 |
| radius 14 | 0.536 | −0.089 | 0.977 | 208 | 16 |
| radius 15 | 0.741 | −0.120 | 0.985 | 216 | 8 |
| radius 16 | 0.976 | −0.125 | 0.991 | 224 | 8 |
| radius 17 | 1.175 | −0.081 | 0.975 | 229 | 5 |
| radius 18 | 1.403 | −0.317 | 0.986 | 234 | 5 |
| radius 19 | 1.791 | −0.448 | 0.978 | 240 | 6 |
| radius 20 | 2.563 | −0.510 | 0.981 | 248 | 8 |
| radius 21 | 4.184 | −1.409 | 0.896 | 256 | 8 |
| radius 22 | −8.731 | −3.334 | 0.074 | 276 | 20 |
| radius 23 | −4.335 | −0.638 | 0.891 | 282 | 6 |
| radius 24 | −2.451 | −0.463 | 0.981 | 292 | 10 |
| radius 25 | −1.433 | −0.211 | 0.993 | 304 | 12 |
| radius 26 | −0.727 | −0.148 | 0.995 | 323 | 19 |
| radius 27 | −0.417 | −0.043 | 0.994 | 337 | 14 |
| radius 28 | −0.219 | 0.246 | 0.966 | 347 | 10 |

Table 1 includes slope (α), y intercept (β), Coefficient of determination (R²), radius angle (counterclockwise from X-axis), and angle between two radii for each of the 28 radii shown in FIG. 3. These data were gained by using the coordinates of 28 radii. As can be seen in Table 1, 20 out of 28 radii have coefficients of determination higher than 90% and 4 out of 28 radii have coefficients of determination higher than 80%. These results imply that using regression lines to express radii is credible.

2) Expression of Spiral Webs in Ellipse Functions

(1) The Structure of a Spider Web

Spiral parts of spider webs resemble ellipses, continuous spirals, interrupted spirals, or interrupted ellipses, and a embodiment of the present invention analyzed elliptical spider webs and spiral spider webs.

(2) Definition of the Ellipse

FIG. 4 is a diagram defining an ellipse. As can be referred from FIG. 4, an ellipse is the collection of all points in the plane that the sum of whose distances from two fixed points, called the foci, is a constant. The line containing foci is called the major axis. The midpoint of the line segment joining the foci is called the center of the ellipse. The line through the center, perpendicular to the major axis, is its minor axis.

If P's coordinates are set as (x,y) and the two foci are set as F(c,0), F′(−c,0) so that the sum of the distances between F, F′ and P are 2a,

P̅F̅+ P̅F̅′=2a (constant)

\sqrt{(x−c)²+y²}+\sqrt{(x+c)²+y²}=2a,\sqrt{(x−c)²+y²}=−\sqrt{(x+c)²+y²}+2a

Since a²−c²=b², if the equation is simplified by being powered, the equation is b²x²+a²y²=a²b²

When both sides of the equation are divided by a²b², the equation of the ellipse is as follows.

$$\frac{{x}^{2}}{{a}^{2}} + \frac{{y}^{2}}{{b}^{2}} = 1 ( only if , a > b > 0 , c = \sqrt{{a}^{2} - {b}^{2}} )$$

(3) Expression of the Rotated Ellipse

FIG. 5 is a diagram of rotated ellipse.

Referring to FIG. 5, a mathematical procedure for inducing ellipse equation whose major axis is rotated from X axis by θ degrees is as follows,

$$( \begin{matrix}{x}^{′} \\ {y}^{′}\end{matrix} ) = ( \begin{matrix}cos θ & - sin θ \\ sin θ & cos θ\end{matrix} ) ( \begin{matrix}x \\ y\end{matrix} )$$

$$( \begin{matrix}x \\ y\end{matrix} ) = ( \begin{matrix}cos θ & sin θ \\ - sin θ & cos θ\end{matrix} ) ( \begin{matrix}{x}^{′} \\ {y}^{′}\end{matrix} )$$

$$x = {x}^{′} cos θ + {y}^{′} sin θ$$

$$y = - {x}^{′} sin θ + {y}^{′} cos θ$$

$$\text{Because} \frac{{x}^{2}}{{a}^{2}} + \frac{{y}^{2}}{{b}^{2}} = 1 , \\ \frac{{( {x}^{′} cos θ + {y}^{′} sin θ )}^{2}}{{a}^{2}} + \frac{{( - {x}^{′} sin θ + {y}^{′} cos θ )}^{2}}{{b}^{2}} = 1$$

If both sides are multiplied by a²b², and (x′, y′) is replaced by (x, y), ellipse equation is as follows,

(a² sin²θ+b² cos²θ)x²−2xy(a²−b²)sin θ cos θ+(a² cos²θ+b² sin²θ)y²−a²b²=0

To simplify the equation,

Ax²+Bxy+Gy²+K=0

(A=a² sin²θ+b² cos²θ, B=−2(a²−b²)sin θ cos θ, G=a² cos²θ+b² sin²θ, K=−a²b²)

### (4) Expression of Ellipse Function Whose Center is Shifted

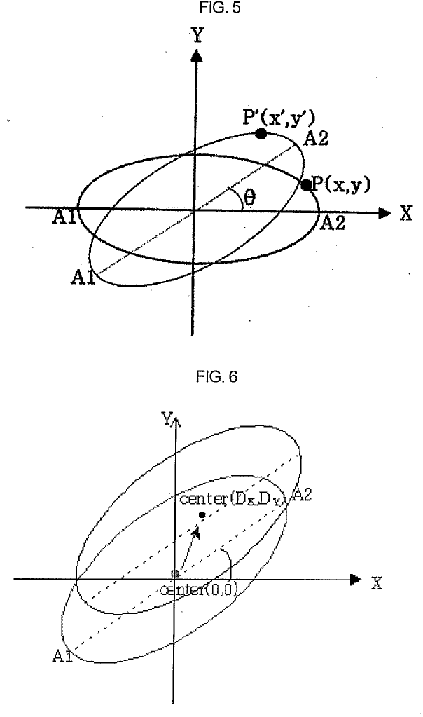

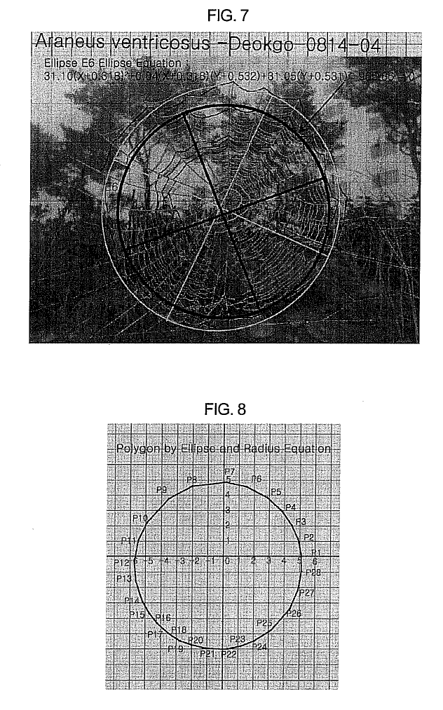

FIG. 6 a diagram of ellipse when its center shifts.

Referring to FIG. 6, when the center of an ellipse whose slope is θ and center (0,0) is shifted to (D_{X},D_{Y}), the equation of the ellipse is as follows

(a² sin² θ+b² cos²θ)(x−D_{X})²−2(x−D_{X})(y−D_{Y})(a²−b²)sin θ cos θ+(a² cos²θ+b² sin²θ)(y−D_{Y})²−a²b²=0

FIG. 7 is a diagram of real spider web on which an ellipse function is shown. Using the equation of the ellipse induced above, the sixth ellipse in FIG. 7 can be expressed in the equation 31.10(X+0.318)²+0.04(X+0.318)(Y+0.532)+31.05(Y+0.531)²−965.86=0.

### 3) Intersections Between Ellipse and Radii

(1) Calculating the Intersections Between Ellipse and Radii

The procedure for calculating intersections between radii and ellipse whose major axis has a slope of θ and center is (D_{X},D_{Y}) is as follows.

Equation of the ellipse is A(x−D_{X})²+B(x−D_{X})(y−D_{Y})+G(y−D_{Y})²+K=0 \textcircled{1}

Equation of the radius is y=αx+β \textcircled{2}

If a simultaneous equation between \textcircled{1} and \textcircled{2} is solved

A(x−D_{X})²+B(x−D_{X})(αx+β−D_{Y})+G(αx+β−D_{Y})²+K=0

(A+Bα+Gα²)x²+{B(β−D_{Y}−α·D_{X})−2A·D_{X}+2Gα(β−D_{Y})}x+A·D_{X}²−B·D_{X}(β−D_{Y})+G(β−D_{Y})²+K=0

To simplify the equation

$${A}^{′} {x}^{2} + {B}^{′} x + {K}^{′} = 0$$

$${A}^{′} = A + B α + G {α}^{2} , \\ {B}^{′} = B ( β - {D}_{Y} - α \cdot {D}_{X} ) - 2 A \cdot {D}_{X} + 2 G α \cdot ( β - {D}_{Y} ) , \\ {K}^{′} = A \cdot {D}_{X}^{2} - B \cdot {D}_{X} ( β - {D}_{Y} ) + {G ( β - {D}_{Y} )}^{2} + K$$

$$x = \frac{- {B}^{′} \pm \sqrt{( {B}^{′2} - 4 {A}^{′} {K}^{′} )}}{2 {A}^{′}}$$

(2) Comparing Modeled Spider Web with Actual Spider Web

The method offered in the present invention uses the intersections between elliptical spirals and radii to model spider webs. After the functions of radii were gained through Regression Analyses, and the functions of ellipses were gained by using the methods mentioned earlier, quadratic equations were solved to calculate intersections.

Two intersection points were gained for every radius because every radius crossed an ellipse at two points. The two points had different signs. The value of x was used as a standard to determine which point is correct for each case. The value of x and y for each of the 4 quadrants are as follows. x>0, y>0 in quadrant 1; x<0, y>0 in quadrant 2; x<0, y<0 in quadrant 3; x>0, y<0 in quadrant 4.

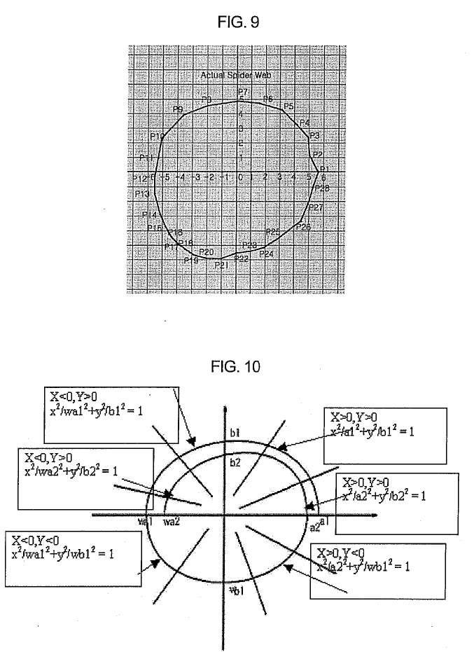

When the intersections of modeled spider webs were connected (Refer to FIG. 8), the modeled spider web was very similar to the actual spider web (Refer to FIG. 9), and when the actual intersections were compared with artificial intersections (the intersections between the ellipses and radii), the error was within tolerance (Refer to Table 4). Differences between actual and artificial intersections were divided by half the length of the major axis to compare the errors among spider webs.

In Table 3, the equation of the ellipse is A(x−D_{X})²+B(x−D_{X})(y−D_{Y})+G(y−D_{Y})²+K=0

The function of ellipse E6:

31.10(x+0.318)²+0.04(x+0.318)(y+0.532)+31.05(y+0.531)²−965.86=0

The function of radius is y=αx+β The function of radius1: y=0.0083x+0.1569

By solving simultaneous equation between the two, the intersections between the ellipse and the radius were calculated. By solving a simultaneous equation for x, the equation takes the form of A′x²+B′x+K′=0. The value of x can be calculated by solving quadratic equation. The value of y can be calculated by using the value of x.

Among the two roots the case x>0, y>0 is chosen if the radius is in quadrant 1; x<0, y>0 if it is in quadrant 2; x<0, y<0 if in quadrant 3; x>0, y<0 if in quadrant 4.

Table 2 includes the ellipse and radial functions, and Table 3 includes the intersections between ellipses and radii and the functions for calculating the intersections. The intersections between the ellipse and 28 radii were calculated and presented in Table 2 and Table 3. In Table 4, the actual intersections were compared with calculated intersections

TABLE 2

| ellipse | | | | | | | | | | | |
|---|---|---|---|---|---|---|---|---|---|---|---|
| major | minor | | | | radius | | | | | | |
| axis | axis | slope | center | | | slope | y intercept | ellipse function | | | |
| a | b | θ | Dₓ | D_{y} | | α | β | A | B | G | K |
| 5.577619 | 5.571965 | 111 | −0.318 | −0.532 | radius 1 | 0.0083 | 0.157 | 31.10 | 0.04 | 31.05 | −965.86 |
| 5.577619 | 5.571965 | 111 | −0.318 | −0.532 | radius 2 | 0.2596 | −0.084 | 31.10 | 0.04 | 31.05 | −965.86 |
| 5.577619 | 5.571965 | 111 | −0.318 | −0.532 | radius 3 | 0.4862 | −0.081 | 31.10 | 0.04 | 31.05 | −965.86 |
| 5.577619 | 5.571965 | 111 | −0.318 | −0.532 | radius 4 | 0.799 | −0.041 | 31.10 | 0.04 | 31.05 | −965.86 |
| 5.577619 | 5.571965 | 111 | −0.318 | −0.532 | radius 5 | 1.3976 | −0.068 | 31.10 | 0.04 | 31.05 | −965.86 |
| 5.577619 | 5.571965 | 111 | −0.318 | −0.532 | radias 6 | 3.1086 | −0.005 | 31.10 | 0.04 | 31.05 | −965.86 |
| 5.577619 | 5.571965 | 111 | −0.318 | −0.532 | radius 7 | 18.114 | 2.175 | 31.10 | 0.04 | 31.05 | −965.86 |
| 5.577619 | 5.571965 | 111 | −0.318 | −0.532 | radius 8 | −2.295 | −0.096 | 31.10 | 0.04 | 31.05 | −965.86 |
| 5.577619 | 5.571965 | 111 | −0.318 | −0.532 | radius 9 | −1.131 | −0.179 | 31.10 | 0.04 | 31.05 | −965.86 |
| 5.577619 | 5.571965 | 111 | −0.318 | −0.532 | radius 10 | −0.471 | −0.045 | 31.10 | 0.04 | 31.05 | −965.86 |
| 5.577619 | 5.571965 | 111 | −0.318 | −0.532 | radius 11 | −0.208 | −0.057 | 31.10 | 0.04 | 31.05 | −965.86 |
| 5.577619 | 5.571965 | 111 | −0.318 | −0.532 | radius 12 | 0.027 | −0.123 | 31.10 | 0.04 | 31.05 | −965.86 |
| 5.577619 | 5.571965 | 111 | −0.318 | −0.532 | radius 13 | 0.2285 | −0.174 | 31.10 | 0.04 | 31.05 | −965.86 |
| 5.577619 | 5.571965 | 111 | −0.318 | −0.532 | radius 14 | 0.5363 | −0.089 | 31.10 | 0.04 | 31.05 | −965.86 |
| 5.577619 | 5.571965 | 111 | −0.318 | −0.532 | radius 15 | 0.7407 | −0.12 | 31.10 | 0.04 | 31.05 | −965.86 |
| 5.577619 | 5.571965 | 111 | −0.318 | −0.532 | radius 16 | 0.9756 | −0.125 | 31.10 | 0.04 | 31.05 | −965.86 |
| 5.577619 | 5.571965 | 111 | −0.318 | −0.532 | radius 17 | 1.1751 | −0.081 | 31.10 | 0.04 | 31.05 | −965.86 |
| 5.577619 | 5.571965 | 111 | −0.318 | −0.532 | radius 18 | 1.4033 | −0.317 | 31.10 | 0.04 | 31.05 | −965.86 |
| 5.577619 | 5.571965 | 111 | −0.318 | −0.532 | radius 19 | 1.7906 | −0.448 | 31.10 | 0.04 | 31.05 | −965.86 |
| 5.577619 | 5.571965 | 111 | −0.318 | −0.532 | radius 20 | 2.5626 | −0.51 | 31.10 | 0.04 | 31.05 | −965.86 |
| 5.577619 | 5.571965 | 111 | −0.318 | −0.532 | radius 21 | 4.1836 | −1.409 | 31.10 | 0.04 | 31.05 | −965.86 |
| 5.577619 | 5.571965 | 111 | −0.318 | −0.532 | radius 22 | −8.731 | −3.334 | 31.10 | 0.04 | 31.05 | −965.86 |
| 5.577619 | 5.571965 | 111 | −0.318 | −0.532 | radius 23 | −4.335 | −0.638 | 31.10 | 0.04 | 31.05 | −965.86 |
| 5.577619 | 5.571965 | 111 | −0.318 | −0.532 | radius 24 | −2.451 | −0.463 | 31.10 | 0.04 | 31.05 | −965.86 |
| 5.577619 | 5.571965 | 111 | −0.318 | −0.532 | radius 25 | −1.433 | −0.211 | 31.10 | 0.04 | 31.05 | −965.86 |
| 5.577619 | 5.571965 | 111 | −0.318 | −0.532 | radius 26 | −0.727 | −0.148 | 31.10 | 0.04 | 31.05 | −965.86 |
| 5.577619 | 5.571965 | 111 | −0.318 | −0.532 | radius 27 | −0.417 | −0.043 | 31.10 | 0.04 | 31.05 | −965.86 |
| 5.577619 | 5.571965 | 111 | −0.318 | −0.532 | radius 28 | −0.219 | 0.246 | 31.10 | 0.04 | 31.05 | −965.86 |

TABLE 3

| | Equation for intersections between | | | | coordinates of intersection | | | |
|---|---|---|---|---|---|---|---|---|
| | ellipse and radius | | | | solution 1 | | solution 2 | |
| radius | A′ | B′ | K′ | R = B′²-4 A′ K′ | X | Y | X | Y |
| radius 1 | 31.10 | 20.17 | −947.97 | 118350.97 | 5.21 | 0.20 | −5.85 | 0.11 |
| radius 2 | 33.21 | 27.04 | −956.47 | 127769.71 | 4.98 | 1.21 | −5.79 | −1.59 |
| radius 3 | 38.46 | 33.44 | −956.38 | 148256.34 | 4.57 | 2.14 | −5.44 | −2.73 |
| radius 4 | 50.96 | 44.17 | −955.23 | 196664.37 | 3.92 | 3.09 | −4.78 | −3.86 |
| radius 5 | 91.82 | 60.05 | −956.04 | 354738.27 | 2.92 | 4.01 | −3.57 | −5.06 |
| radius 6 | 331.34 | 121.58 | −954.09 | 1279271.36 | 1.52 | 4.73 | −1.89 | −5.88 |
| radius 7 | 10221.88 | 3065.04 | −735.21 | 39455543.06 | 0.16 | 5.02 | −0.46 | −6.11 |
| radius 8 | 194.52 | −42.38 | −956.80 | 746272.56 | 2.33 | −5.44 | −2.11 | 4.75 |
| radius 9 | 70.76 | −4.97 | −958.85 | 271403.41 | 3.72 | −4.38 | −3.65 | 3.94 |
| radius 10 | 37.97 | 5.58 | −955.36 | 145133.41 | 4.94 | −2.37 | −5.09 | 2.35 |
| radius 11 | 32.44 | 13.66 | −955.71 | 124209.93 | 5.22 | −1.15 | −5.64 | 1.12 |
| radius 12 | 31.13 | 20.50 | −957.51 | 119632.21 | 5.23 | 0.02 | −5.89 | −0.28 |
| radius 13 | 32.73 | 24.88 | −958.74 | 126147.79 | 5.05 | 0.98 | −5.81 | −1.50 |
| radius 14 | 40.06 | 34.58 | −956.60 | 154473.22 | 4.47 | 2.31 | −5.34 | −2.95 |
| radius 15 | 48.17 | 38.75 | −957.45 | 185991.05 | 4.07 | 2.90 | −4.88 | −3.73 |
| radius 16 | 60.70 | 44.45 | −957.58 | 234485.27 | 3.62 | 3.41 | −4.35 | −4.37 |
| radius 17 | 74.03 | 52.71 | −956.40 | 285994.61 | 3.26 | 3.74 | −3.97 | −4.74 |
| radius 18 | 92.31 | 38.58 | −961.27 | 356433.52 | 3.02 | 3.93 | −3.44 | −5.15 |
| radius 19 | 130.74 | 29.13 | −962.49 | 504209.92 | 2.60 | 4.21 | −2.83 | −5.51 |
| radius 20 | 235.14 | 23.30 | −962.70 | 906036.00 | 1.97 | 4.55 | −2.07 | −5.82 |
| radius 21 | 574.82 | −208.20 | −938.81 | 2201939.42 | 1.47 | 4.75 | −1.11 | −6.05 |
| radius 22 | 2397.79 | 1589.05 | −718.90 | 9263740.83 | 0.31 | −6.07 | −0.96 | 5.01 |
| radius 23 | 614.56 | 48.24 | −962.37 | 2368049.42 | 1.21 | −5.90 | −1.29 | 4.96 |
| radius 24 | 217.60 | 9.26 | −962.56 | 837917.84 | 2.08 | −5.57 | −2.12 | 4.75 |
| radius 25 | 94.77 | −8.77 | −959.51 | 363816.04 | 3.23 | −4.84 | −3.14 | 4.28 |
| radius 26 | 47.47 | 2.48 | −958.14 | 181939.08 | 4.47 | −3.39 | −4.52 | 3.14 |
| radius 27 | 36.49 | 7.13 | −955.28 | 139487.42 | 5.02 | −2.14 | −5.22 | 2.13 |
| radius 28 | 32.58 | 9.24 | −943.92 | 123110.91 | 5.24 | −0.90 | −5.53 | 1.46 |

R = B′²-4 A′ K′

TABLE 4

| | coordinates of | | real | | distance | D/a(half |
|---|---|---|---|---|---|---|
| | intersection(I) | | coordinates(R) | | between I | length of |
| | X | Y | X | Y | and R (D) | major axis) |
| radius 1 | 5.21 | 0.20 | 5.77 | 0.08 | 0.58 | 0.10 |
| radius 2 | 4.98 | 1.21 | 5.14 | 1.25 | 0.17 | 0.03 |
| radius 3 | 4.57 | 2.14 | 5.05 | 2.48 | 0.59 | 0.10 |
| radius 4 | 3.92 | 3.09 | 4.25 | 3.42 | 0.46 | 0.08 |
| radius 5 | 2.92 | 4.01 | 3.20 | 4.43 | 0.50 | 0.09 |
| radius 6 | 1.52 | 4.73 | 1.58 | 4.88 | 0.16 | 0.03 |
| radius 7 | 0.16 | 5.02 | 0.12 | 5.06 | 0.05 | 0.01 |
| radius 8 | −2.11 | 4.75 | −2.03 | 4.69 | 0.10 | 0.02 |
| radius 9 | −3.65 | 3.94 | −3.71 | 4.09 | 0.16 | 0.03 |
| radius 10 | −5.09 | 2.35 | −5.21 | 2.40 | 0.13 | 0.02 |
| radius 11 | −5.64 | 1.12 | −5.47 | 1.05 | 0.19 | 0.03 |
| radius 12 | −5.89 | −0.28 | −5.71 | −0.25 | 0.18 | 0.03 |
| radius 13 | −5.81 | −1.50 | −5.70 | −1.45 | 0.12 | 0.02 |
| radius 14 | −5.34 | −2.95 | −5.30 | −2.89 | 0.07 | 0.01 |
| radius 15 | −4.88 | −3.73 | −4.94 | −3.77 | 0.07 | 0.01 |
| radius 16 | −4.35 | −4.37 | −4.50 | −4.50 | 0.20 | 0.04 |
| radius 17 | −3.97 | −4.74 | −4.11 | −4.88 | 0.20 | 0.04 |
| radius 18 | −3.44 | −5.15 | −3.59 | −5.32 | 0.23 | 0.04 |
| radius 19 | −2.83 | −5.51 | −2.97 | −5.75 | 0.27 | 0.05 |
| radius 20 | −2.07 | −5.82 | −2.12 | −5.96 | 0.15 | 0.03 |
| radius 21 | −1.11 | −6.05 | −1.07 | −6.02 | 0.05 | 0.01 |
| radius 22 | 0.31 | −6.07 | 0.00 | −5.63 | 0.54 | 0.10 |
| radius 23 | 1.21 | −5.90 | 1.10 | −5.47 | 0.44 | 0.08 |
| radius 24 | 2.08 | −5.57 | 1.94 | −5.23 | 0.37 | 0.07 |
| radius 25 | 3.23 | −4.84 | 3.05 | −4.54 | 0.35 | 0.06 |
| radius 26 | 4.47 | −3.39 | 4.58 | −3.37 | 0.11 | 0.02 |
| radius 27 | 5.02 | −2.14 | 5.06 | −2.17 | 0.05 | 0.01 |
| radius 28 | 5.24 | −0.90 | 5.40 | −1.01 | 0.19 | 0.03 |

As shown in Table 4, mean of D/a(Distance between every intersection point and real point/half the length of major axis) is 0.0428 and standard deviation of D/a is 0.0305. Thus, mathematically expressed spider web resembles actual spider web. Especially, this result implies that by connecting the intersections between radii which start from the center of ellipse and ellipses, spirals of spider webs can be expressed.

4) Expression of Spiral Webs in Spiral Functions

(1) Functionalization of Spiral Spider Webs

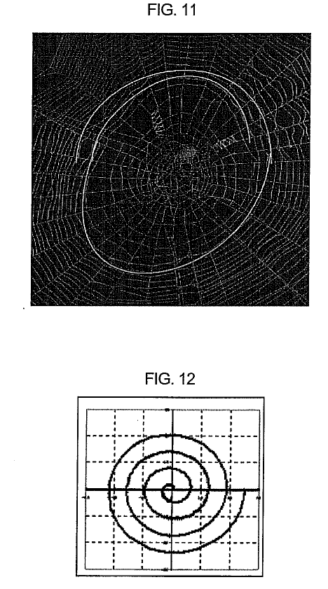

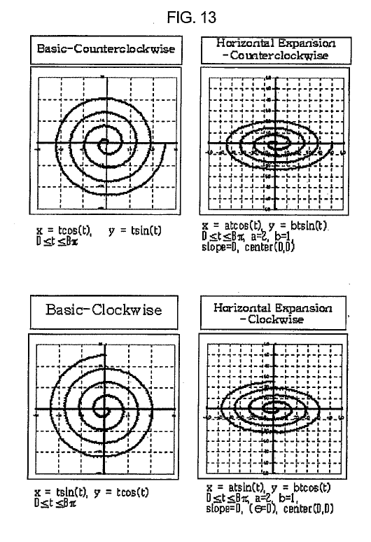

If the spiral part of spider web is spiral-shaped, an ellipse whose major axis and minor axis change for every quadrant can be applied to express a spiral-shaped spiral web. FIG. 10 is a diagram showing functions of elliptical spiral line that circumscribes polygons and changes for every quadrant, and FIG. 11 is a picture showing the spiral part of a real web which can be expressed in spiral functions (in parametric equations).

Portions of ellipses that make up a spiral in FIG. 10 have major axes which are parallel to the X-axis and centers in the middle of the coordinates. When a spider web's major axis has a slope of θ and a center point (Dx, Dy), it can be expressed mathematically by using the methods mentioned earlier at the part that explains the process of inducing generalized ellipse function.

Lengths of major and minor axis for each quadrant can be varied by setting certain conditions. Specifically, the polygon-circumscribing ellipse can be divided into four quadrants as shown in FIG. 10 or more sections (for example, eight or twelve). It is also possible to use polar equation to express general spiral forms in functions.

Archimedes spiral can be used to express spider webs which have continuous spirals. Archimedes spiral's vector function is r(t)=(t cos t)i+(t sin t)j, t≧0, which is equal to the curve, x=t cos t, y=t sin t, t≧0. As t increases, the point (x,y) starts at the origin (0,0) and winds around the origin, getting farther away from it (See FIG. 12). In a embodiment of the present invention, the parametric equation of Archimedes Sprial was generalized for application to spiral webs.

(2) Generalization of Archimedes Spiral

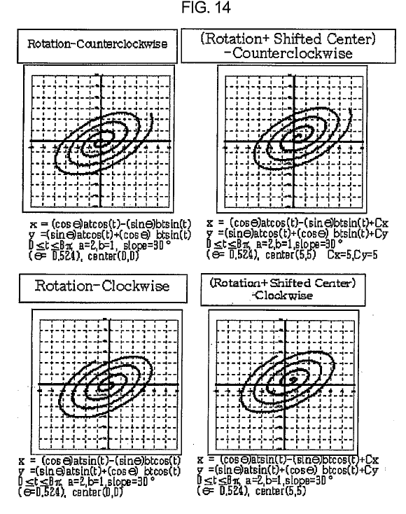

FIG. 13 is a group diagram of spiral webs expressed in generalized spiral functions

Referring to FIG. 13, Archimedes spiral can largely be divided into two kinds according to the direction it winds; clockwise or counterclockwise.

Archimedes spiral that winds counterclockwise can be expressed as x=t cos t, y=t sin t in parametric equation, and Archimedes spiral that winds clockwise can be expressed as x=t sin t, y=t cos t (The above is true only if t is an angle expressed in radian, and t>=0). In a embodiment of the present invention, the counterclockwise-winding spiral will be mainly used for explanations.

The application of clockwise-winding spirals will be presented later in the embodiment of the present invention.

Basic spiral has center at the point of origin. It either winds clockwise or counterclockwise. If this spiral function is generalized to include spirals that are expanded either vertically or horizontally, the parametric equation of counterclockwise-winding spiral is x=at cos t, y=bt cos t when a and b are random constants. If a<b, the spiral expands vertically and the vertical axis(X-axis) of spiral becomes the major axis, and if a>b, the spiral expands horizontally and the horizontal axis(X-axis) becomes the major axis.

Specifically, in order to calculate both a and b, the intersections between spiral and the axes should be calculated as the intersections between ellipse and its major, minor axis were calculated for elliptical spider webs. If the intersections between the spiral and X-axis are nominated as A(x,y) and B(x′, y′) t and a can be calculated by using the relationship between the two points A and B.

In addition, if the intersections between the spiral and Y-axis are nominated as C(x,y) and D(x′, y′), the value of t and b can be calculated by using the relationship between the two points C and D. Thus, even if the function of spiral is unknown, the intersections between the spiral and X, Y axes (or any axis) can be used to induce the generalized function for the spiral by using two intersections for each axis.

The method for calculating t of the intersection between radius and spiral is as follows. To calculate the intersections between a radius whose slope is α(y=αx) and a spiral expressed in parametric equation as x=at cos t, y=bt sin t, the final form which comes out as αa/b=tan(t) must be used. So if the values of α, a, and b are given, the value of t can be calculated (The above is true only if t is a value expressed in radian).

(3) Mathematical Expression of Rotated Spiral Whose Center is Shifted

FIG. 14 is a group diagram of spiral webs expressed in generalized spiral functions that are rotated and whose centers are shifted.

Referring to FIG. 14, like ellipse function, spiral functions whose major axis is rotated for θ degrees and whose center is shifted to (Cx, Cy) can be mathematically expressed.

Archimedes spiral assumes various shapes according to the direction it winds, relative expansion of its major and minor axes (ratios of horizontal and vertical expansions), the location of its center, and the slope of the major and minor axes. In order to express any kind of spider web, rotated Archimedes spiral that has shifted center and has relatively stretched major, minor axes was functionalized.

5) Intersections Between Archimedes Spiral and Radii

(1) Functions of Radii

Radii were considered as linear functions going through the point of origin (that is, the hub of spider web and the point of origin are same), and radius was expressed as y=αx. (β=0)

(2) Intersections Between Radii and Spirals Expressed in Spiral Function

After radii were functionalized in linear functions, the intersections between the radii and spirals expressed in spiral functions were calculated. Then, the intersections were connected to model spider webs. In a embodiment of the present invention, the intersections between basic counterclockwise-winding spiral and radii were used to illustrate a modeled spider web. The procedure for the above process is as follows.

\textcircled{1} Calculate the intersections between radii and spirals

\textcircled{2} Connect the intersections

(3) Modeling of Spiral Spider Webs (Basic-Counterclockwise)

y=αx \textcircled{1}

x=at cos(t) \textcircled{2}

y=bt sin(t) \textcircled{3}

As can be referred from \textcircled{1}, \textcircled{3} αx=bt sin(t) \textcircled{4}

As can be referred from \textcircled{2}, \textcircled{4} (that is, if \textcircled{2} is put into \textcircled{4})

$$α ( at cos ( t ) ) = bt sin ( t )$$

$$a α cos ( t ) = b sin ( t )$$

$$\frac{sin ( t )}{cos ( t )} = \text{?} = tan ( t )$$

$$\text{?} \text{indicates text missing or illegible when filed}$$

In the above equation, many values for t can be gained. As for A1, since the t value of A1 is larger than 0 and smaller than 90 (in the first quadrant), only one t value is selected among the t values gained at the first place (If this value is assume as t1, than the other procedures are as follows).

If t value for the radial function is already given, that is, if the value of θ is already given, than the process listed above can be avoided. For example, if the number of radii is 18, and the angles between radii are constant, then the angles become 20, 40, 60 . . . . (In order to use these angles for functions, they must be changed into radian values first)

TABLE 5

| Intersections | t value | x value | y value |
|---|---|---|---|
| A1 | t1 | a(t1)cos(t1) | b(t1)sin(t1) |
| A2 | t2 = t1 + 2π | a(t2)cos(t2) | b(t2)sin(t2) |
| A3 | t3 = t1 + 4π | a(t3)cos(t3) | b(t3)sin(t3) |
| A4 | t4 = t1 + 6π | a(t4)cos(t4) | b(t4)sin(t4) |
| . . . | . . . | . . . | . . . |

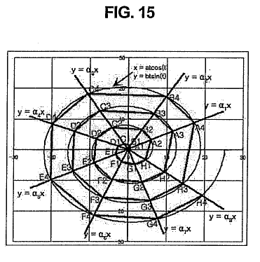

B1, B2, B3, B4 . . . can be calculated in the same method as suggested above, and if the intersections A1, B1, C1, D1, E1, F1, G1, H1, A2, B2, C2, . . . are connected, the spiral web as shown in FIG. 15 will be gained.

If the final t value is t+n*(2*π), then the total number of winding of spirals becomes n. In case of FIG. 15, final t value will be t+8π because the total number of winding of spirals is 4.

By using this process, spider webs can be expressed as intersections between spiral functions and radial functions. By using the functions induced in the procedure, a foundation for computer modeling could be prepared.

Hereinafter, the method of modeling spider webs by applying the radial functions and spiral or ellipse functions to computer programming will be suggested. Programming process required for computer modeling of spider webs will be presented, and an actual application case of spider web into computer modeling will also be presented.

2. Modeling of Spider Webs by Using Computer Programming

1) Modeling of Spider Webs by Using Radial Functions and Ellipse Functions

(1) The Flow Chart for Modeling Elliptical Spider Webs

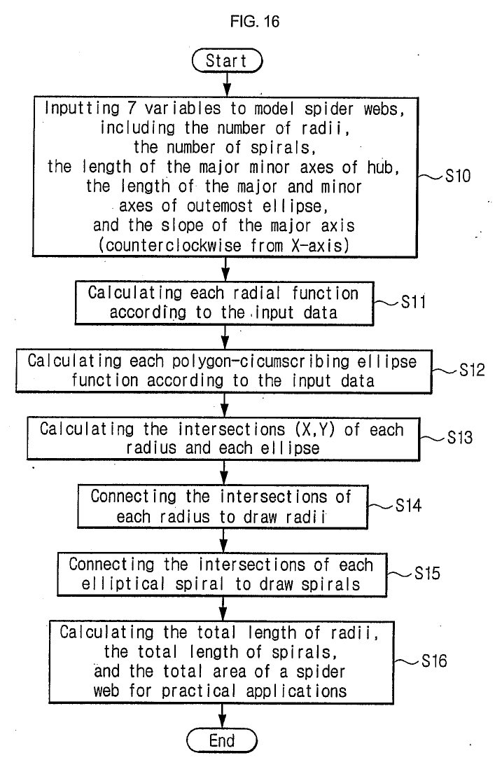

FIG. 16 is a flow chart for modeling spider webs by using radial and ellipse functions, the method of modeling spider webs according to the embodiment of the present invention.

Because of the detailed explanations of the functions included in the flow chart at the front part (mathematical expression of spider webs), the detailed explanations regarding the functions will be skipped in this part.

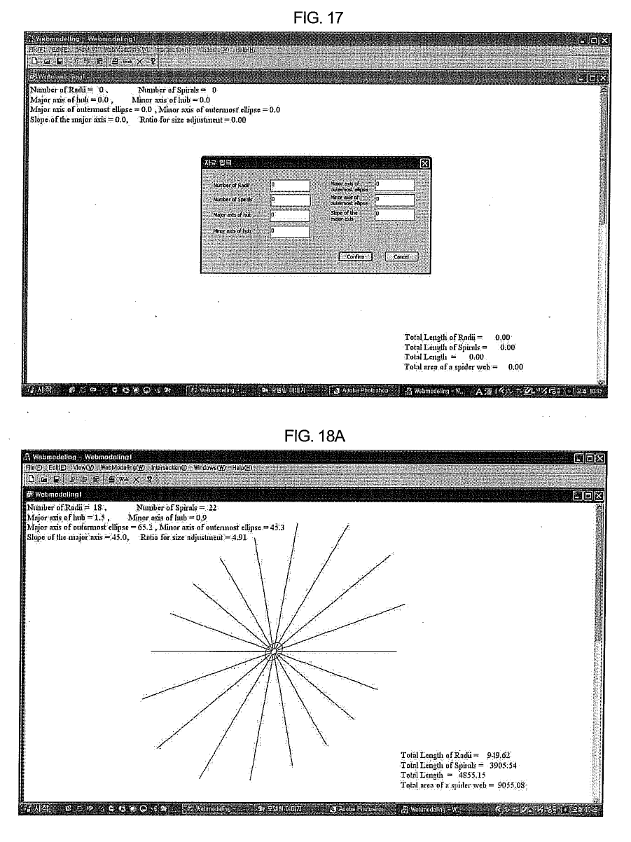

Referring to FIG. 16, the program receives seven variables to model spider webs in step S10. These variables include the number of radii, the number of spirals, the length of the major and minor axes of hub, the length of the major and minor axes of outermost ellipse, and the slope of the major axis (counterclockwise from X-axis). These variables can be changed randomly according to size and shape of the spider web the designer wishes to produce. FIG. 17 is a computer screen into which data for computer modeling are input (to model elliptical spider webs).

Once the data are input, the program calculates the functions of radii according to the input data in step S11.

The program also calculates the functions of ellipses according to the input data in step S12.

Using the radial and ellipse functions, the program calculates the intersections (X, Y) of each radius and each ellipse in step S13.

Using the intersections calculated in step S13, the program connects the intersections of each radius to draw radii in step 14.

Using the intersections calculated in step S13, the program connects the intersections of each elliptical spiral to draw spirals in step S15.

Following the steps S10 to S15 mentioned above, the program produces a modeled spider web based on the input data.

Finally, the program calculates the total length of radii, the total length of spirals, and the total area of a spider web for more convenient application of modeled spider web in step S16.

(2) Header file for the program that calculates the intersections

```
#ifndef SPIDERWEB_H_{—}
#define SPIDERWEB_H_{—}
#include <iostream>
#include <string.h>
#include <math.h>
#const double PI=3.14159265359;
#const int RADIUSBUF= 100; // Set the number for radius array
#const int SPIRALBUF= 100; // Set the number for spiral array
////// class Radius Radius-related class
class Radius
private:
  double theta[RADIUSBUF]; // Calculates the angle of radius
protected:
  double slp[RADIUSBUF]; // slope of the radius
  int quad[RADIUSBUF]; // the quadrant that radius belongs to
  int Rcount; // the number of radii
public:
  Radius( );
  Radius(int Rcnt); // Constructor
  void ThetaCmpt( ); // Calculates the angles of radius
  void SlpCmpt( ); // Calculates the slope of radius
;
////// class Ellipse // Ellipse function-related class
class Ellipse
  private:
    double a_diff, b_diff; // difference between the two major axes of ellipse,
difference between the two minor axes of ellipse (outermost-hub)
  protected:
    double a_begin, b_begin, a_end, b_end; // Major axis of ellipse a, Minor axis of
ellipse b (major axis of the outermost ellipse // a_end, minor axis of the hub //
b_begin)
    int Ecount; // number of spirals
    double a[SPIRALBUF]; // Array for the length of the major axis of ellipse
    double b[SPIRALBUF];
    double eangle; // slope of the major axis of ellipse
  public:
    Ellipse( );
    Ellipse(double a_b,double b_b,double a_e,double b_e,int Ecnt,double etheta);
    void DiffCmpt( );
    void abCmpt( );
;
////// class Intersection class for calculating the x, y coordinates of intersections
class Intersection : public Radius, public Ellipse
  public:
  double inter[SPIRALBUF][RADIUSBUF][2];
  double etheta;
    public:
  Intersection( );
  Intersection(int Rcnt,int Ecnt, double a_b, double b_b,
  double a_e, double b_e, double etheta);
  double xIntersection(double rslp, int rquad, double ea, double eb, double etheta );
    // Calculates the X coordinates of intersections
  double y Intersection(double rslp, double x);// Calculates the Y coordinates of
intersections
  void xy Cmpt( ); // Calculates the X, Y coordinates of intersections
  ;
////// class Input Data Class that deals with data input
class Input Data
    public:
  int Rcnt;
  int Ecnt;
  double a_b;
  double b_b;
  double a_e;
  double b_e;
  double angle;
  double Adj,a,b; // adj → Ratio for size adjustment
    public:
  InputData( );
  InputData(int Rcount, int Ecount, double a_beg,double b_beg,
    double a_end, double b_end, double slope);
  ;
#endif
```

(3) An Actual Case of Modeling

Table 6 shows the input data to gain intersections

TABLE 6

| | | | | | | | slope of |
|---|---|---|---|---|---|---|---|
| | | | major | minor | major axis of | minor axis of | major axis |
| | number | number of | axis of | axis of | outmost | outmost | (from X- |
| | of radii | spirals | hub | hub | ellipse | ellipse | axis) |
| Input | 18 | 22 | 1.5 | 0.9 | 65.2 | 45.3 | 45 |
| data | | | | | | | |

The intersections gained by using the data in Table 6 are shown in Table 7

TABLE 7

| Spiral number = 0 | | Spiral number = 1 | |
|---|---|---|---|
| (spiral number, | | (spiral number, | |
| radius number) → (X, Y) | | radius number) → (X, Y) | |
| (0, 0) | (1.228, 0.446955) | (1, 0) | (3.8483, 1.40067) |
| (0, 1) | (1.14139, 0.957736) | (1, 1) | (3.45621, 2.9001) |
| (0, 2) | (0.708972, 1.22798) | (1, 2) | (2.17654, 3.76988) |
| (0, 3) | (0.206902, 1.1734) | (1, 3) | (0.661741, 3.75292) |
| (0, 4) | (−.0175894, −0.997545) | (1, 4) | (−0.579278, 3.28525) |
| (0, 5) | (−0.459968, 0.796688) | (1, 5) | (−1.53612, 2.66064) |
| (0, 6) | (−0.691122, 0.57992) | (1, 6) | (−2.31399, 1.94166) |
| (0, 7) | (−0.898643, 0.327079) | (1, 7) | (−2.98513, 1.0865) |
| (0, 8) | (−1.09141, −2.26214e−013) | (1, 8) | (−3.54977, −7.3575e−013) |
| (0, 9) | (−1.228, −0.446955) | (1, 9) | (−3.8483, −1.40067) |
| (0, 10) | (−1.14139, −0.957736) | (1, 10) | (−3.45621, −2.9001) |
| (0, 11) | (−3.14159, 5.4414) | (1, 11) | (−2.17654, −3.76988) |
| (0, 12) | (−0.206902, −1.1734) | (0, 12) | (−0.661741, −3.75292) |
| (0, 13) | (0.175894, −0.997545) | (0, 13) | (0.579278, −3.28525) |
| (0, 14) | (0.459968, −0.796688) | (0, 14) | (1.53612, −2.66054) |
| (0, 15) | (0.691122, −0.57992) | (0, 15) | (2.31399, −1.94166) |
| (0, 16) | (0.898643, −0.327079) | (0, 16) | (2.98513, −1.0865) |
| (0, 17) | (1.09141, 4.52427e−013) | (0, 17) | (3.54977, 1.4715e−012 |

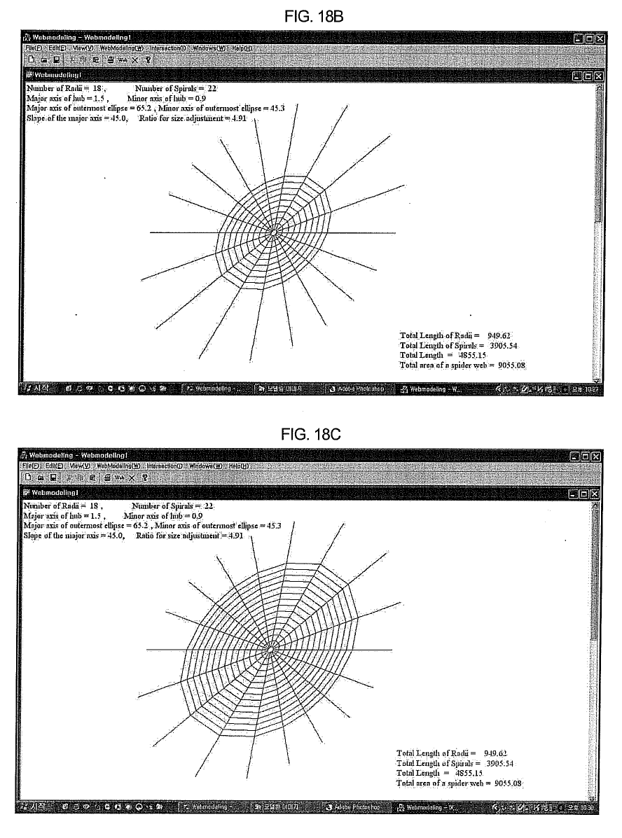

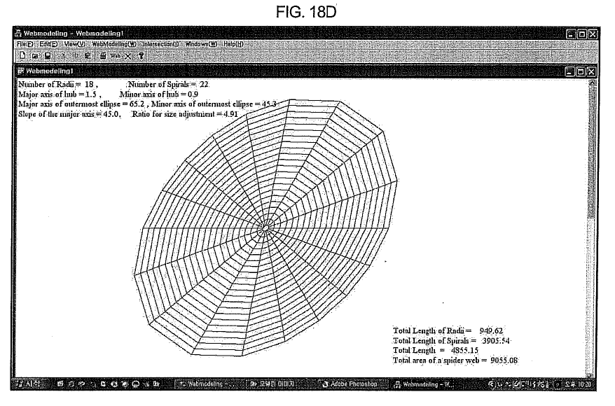

FIG. 18A to 18D show the computer modeling process of spider web, using the intersections shown in Table 7. FIG. 18A is a picture showing the radii drawn by connecting the intersections of radii in Table 7, and FIGS. 18B and 18C are pictures showing the ellipses drawn by connecting the intersections of spirals in Table 7. FIG. 18D is a picture showing the modeled spider web which is based on the input data. The total length of radii, total length of spirals, and the total area of a spider web are calculated and displayed in the right-below corner.

2) Modeling of Spider Webs by Using Radial Functions and Spiral Functions

(1) The Flow Chart for Modeling Spiral Spider Webs

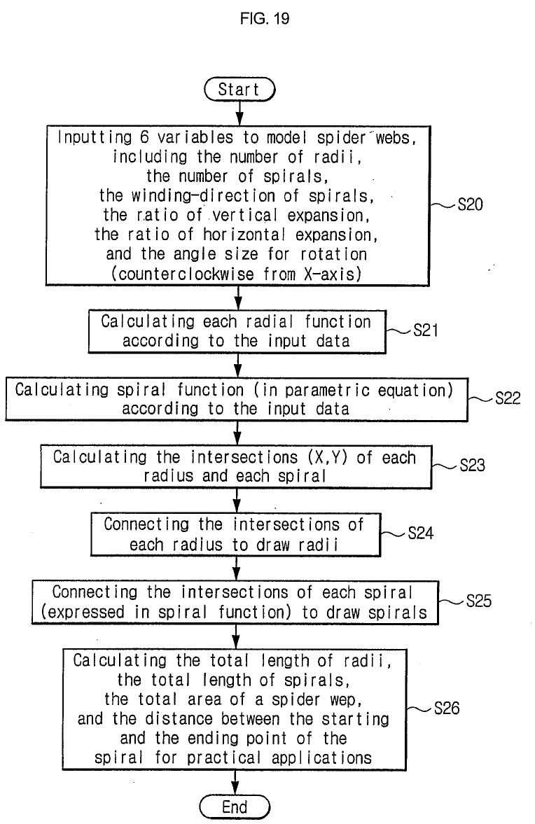

FIG. 19 is a flow chart for modeling spider webs by using radial functions and spiral function (in parametric equation), the other method of modeling spider webs according to the embodiment of the present invention. The detailed explanation about the functions included in the flow chart is already given at the part regarding mathematical expression of spider web, so the detailed explanations will be skipped in this part.

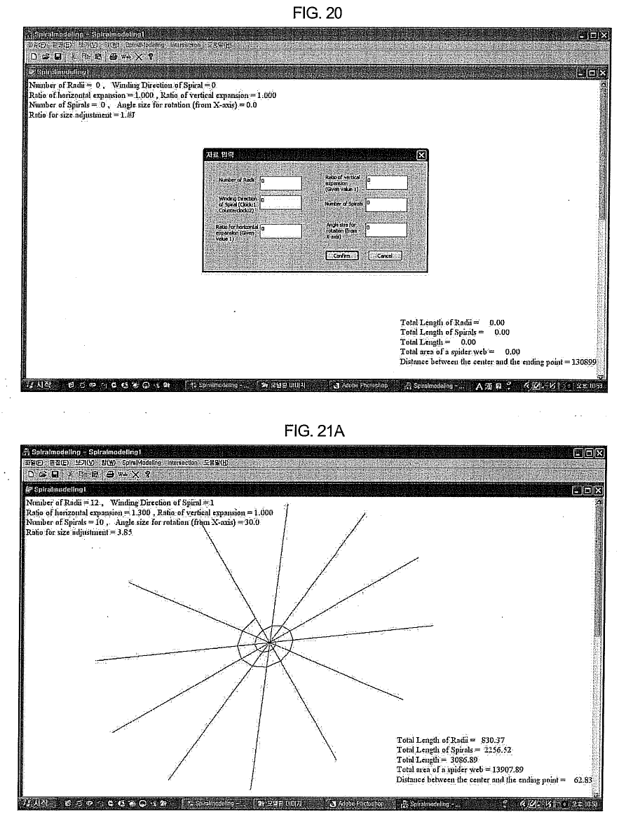

Referring to FIG. 19, the program receives 6 variables to model spider webs in step S20. These variables include the number of radii, the number of spirals, the winding direction of spiral, the ratio of vertical expansion, the ratio of horizontal expansion, and the angle size for rotation (counterclockwise from X-axis). These variables can be changed randomly according to the size and shape of the web the designer wishes to make. FIG. 20 is a computer screen into which data for computer modeling of spiral spider webs are input.

Once the data are input, the program calculates the functions of radii according to the input data in step S21.

The program also calculates the spiral function (expressed in parametric equation) according to the input data in step S22.

Using the radial functions and spiral function, the program calculates the intersections (X, Y) of each radius and each spiral in step S23.

Using the intersections calculated in step S23, the program connects the intersections of each radius to draw radii in step S24.

Using the intersections calculated in step S23, the program connects the intersections of spiral expressed in spiral function to draw spirals in step S25.

Following the steps S20 to S25 mentioned above, the program produces a modeled spider web based on the input data.

Finally, the program calculates the total length of radii, the total length of spirals, the total area of a spider web, and the distance between the starting and the ending point of the spiral for more convenient application of modeled spider web in step S26.

(2) Header file for program that calculates the intersections

```
#include <stdio.h>
#include <math.h>
#include <afx.h>
#ifndef SPIRAL_H_{—}
#define SPIRAL_H_{—}
const double PI = 3.14159265359;
class CSpiral
private:
  int Direction; // Clockwise 1 , Counterclockwise 2 , Finish drawing 0
  double a_sp; // Ratio of spiral's horizontal expansion(Given value= 1)
  double b_sp; // Ratio of spiral's vertical expansion(Given value= 1)
  double theta_sl; // slope of spiral(counterclockwise from X-axis)
public:
  int Rcount; // number of radii
  int n_sp; // winding number of spirals
  double intersections_sp[100][100][2]; //save intersections as array
  double adj1; //ratio for size adjustment
public:
  CSpiral( );
  CSpiral(int rcnt, int dire, double a, double b, int ns, double theta);
  void CmptInter(void); // function that calculates the intersections
  ~CSpiral(void);
  void Input(int rcnt, int dire, double a, double b, int ns, double theta);
// input data
;
#endif
```

(3) An Actual Case of Modeling

Table 8 shows the input data to gain intersections

TABLE 8

| | | direction of | | | | |
|---|---|---|---|---|---|---|
| | | winding(clock: | | vertical | | |
| | number | 1, | horizontal | expansion | number | slope of spiral |
| | of radii | counterclock: 2) | expansion rate | rate | of spirals | (from x-axis) |
| Input | 12 | 1 | 1.3 | 1 | 10 | 30 |
| data | | | | | | |

The intersections gained by using the data in Table 8 are shown in Table 9

TABLE 9

| Spiral number = 0 | | Spiral number = 1 | |
|---|---|---|---|
| (spiral number, | | (spiral number, | |
| radius number) → (X, Y) | | radius number) → (X, Y) | |
| (0, 0) | (0.0680175, 0.562869) | (1, 0) | (0.884227, 7.31729) |
| (0, 1) | (0.759218, 1.04293) | (1, 1) | (5.31453, 7.30054) |
| (0, 2) | (1.76845, 1.02102) | (1, 2) | (8.84227, 5.10509) |
| (0, 3) | (2.56563, 0.27207) | (1, 3) | (10.2625, 1.08828) |
| (0, 4) | (2.60734, −1.11265) | (1, 4) | (8.86494, −3.783) |
| (0, 5) | (1.5708, −2.7207) | (1, 5) | (4.71239, −8.1621) |
| (0, 6) | (−0.476122, −3.94008) | (1, 6) | (−1.29233, −10.6945) |
| (0, 7) | (−3.03687, −4.17174) | (1, 7) | (−7.59218, −10.4293) |
| (0, 8) | (−5.30536, −3.06305) | (1, 8) | (−12.3792, −7.14712) |
| (0, 9) | (−6.41409, −0.680175) | (1, 9) | (−14.111, −1.49638) |
| (0, 10) | (−5.73614, 2.44782) | (1, 10) | (−11.9937, 5.11818) |
| (0, 11) | (−3.14159, 5.4414) | (1, 11) | (−6.28319, 10.8828) |

(Intersection coordinates between radii and spirals from no. 2 to no. 9 are omitted)

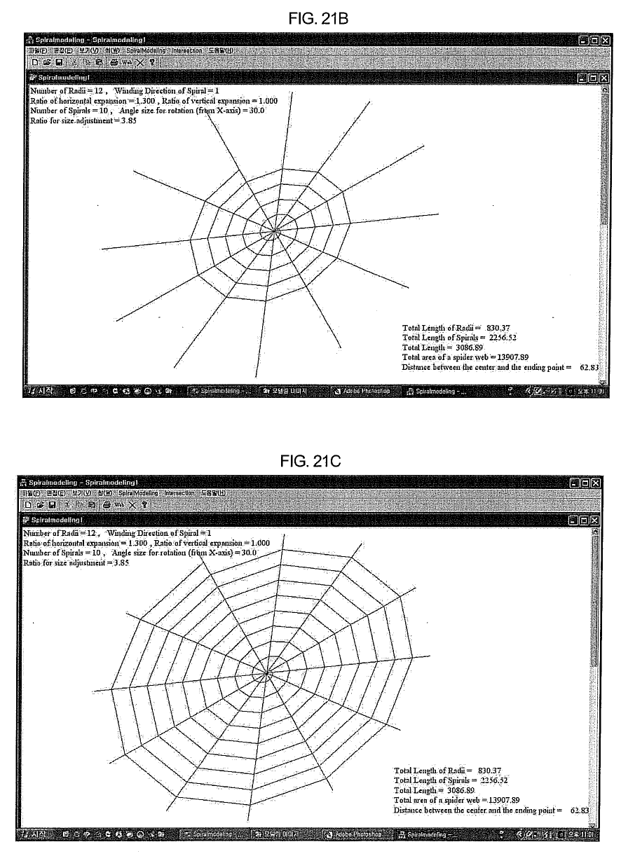

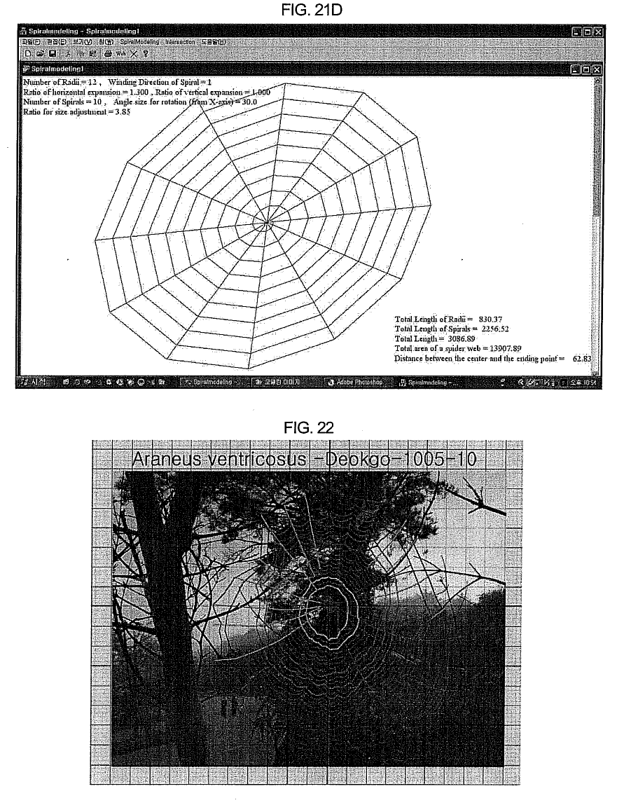

FIG. 21A to 21D show the computer modeling process of spiral spider webs using the coordinates of intersections shown in table 9. FIG. 21A is a picture showing the radii drawn by connecting the intersections of each radius in Table 9, and FIGS. 21B and 21C are pictures showing the spirals drawn by connecting the intersections of spiral function in Table 9. FIG. 21D is a picture showing the modeled spider web which is based on the input data. The total length of radii, total length of spirals, the total area of a spider web, and the distance between the starting and ending points of spiral are calculated and displayed in the right-below corner.

As can be seen in the above process, by inducing functions for radii and spirals from real spider webs and applying the functions to computer modeling, the embodiment of the present invention allows users to model all kinds of spider webs.

In the next step, by inputting data from real spider webs and modeling spider webs through computer programming, the resemblance of the modeled web to the real spider web will be shown.

FIG. 22 is the real spider web from which input data for computer modeling are gained.

First, from the real spider web shown in FIG. 22, count the number of radii, count the number of spirals, and gain other data that would be input to model spider webs that are expressed in radial functions and ellipse functions. Data gained in the process are shown in Table 10.

TABLE 10

| | | | | | | | slope of major |
|---|---|---|---|---|---|---|---|
| | | number | major | minor | major axis | minor axis of | axis |
| | number | of | axis of | axis of | of outmost | outmost | (counterclockwise |
| | of radii | spirals | hub | hub | ellipse | ellipse | from X-axis) |
| Input data | 27 | 19 | 0.4 | 0.2 | 6.4 | 6.3 | 114 |

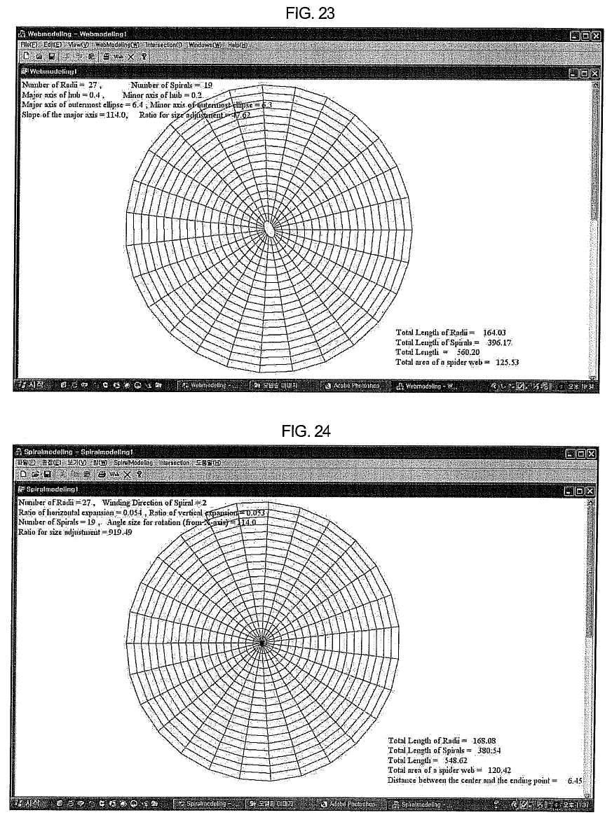

The result of the modeling, once the data on Table 10 are input, is shown in FIG. 23.

FIG. 23 is a picture of an elliptical spider web modeled by using the data gained from the real spider web in FIG. 22.

As shown in FIG. 23, the modeled spider web is very similar to the real web.

Next, from the real spider web shown in FIG. 22, count the number of radii, find the winding direction of spiral, and gain other data that would be input to model spider webs that use radial functions and spiral function. Data gained in the process are shown in Table 11.

TABLE 11

| | | direction of | | vertical | | slope of spiral |
|---|---|---|---|---|---|---|
| | number | winding(clock: 1, | horizontal | expansion | number | (counterclockwise |
| | of radii | counterclock: 2) | expansion rate | rate | of spirals | from x-axis) |
| Input data | 27 | 2 | 0.054 | 0.053 | 19 | 114.0 |

The result of the modeling, once the data on Table 11 are input, is shown in FIG. 24.

FIG. 24 is a picture of a spiral spider web modeled by using the data gained from real spider web in FIG. 22.

As shown in FIG. 24, the modeled spider web is very similar to the real web.

As can be referred from above, because computer modeled spider webs are very similar to the real spider webs, practical applications of spider webs will be possible to the fields that require elasticity and stability. Among the probable fields of applications, the net of badminton racket is used as an example to which the modeled spider web will be applied.

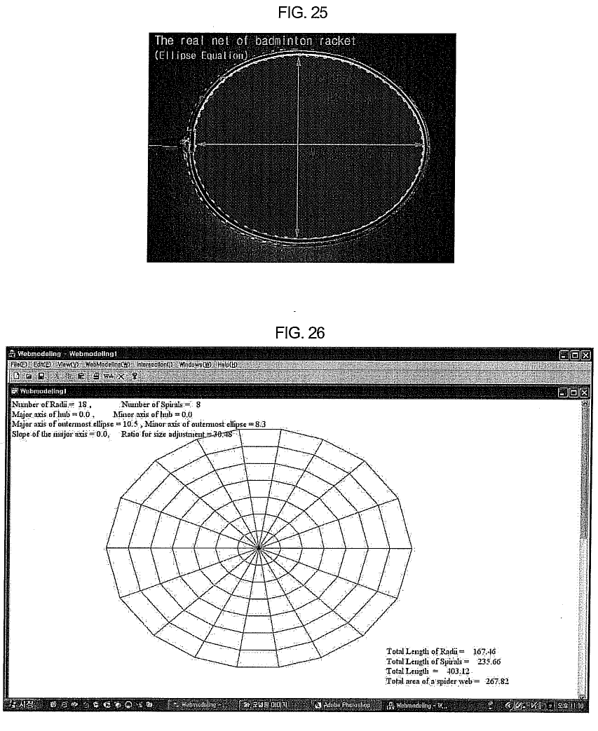

FIG. 25 is a picture of a badminton racket to which computer modeled elliptical spider web will be applied.

The head of the badminton racket illustrated in FIG. 25 is 23 cm in width and 18.5 in height. Based on the size of the badminton racket, Table 12 shows the possible input data to model spider webs.

TABLE 12

| | | | | | | | slope of major |
|---|---|---|---|---|---|---|---|
| | | number | major | minor | major axis | minor axis of | axis |
| | number | of | axis of | axis of | of outmost | outmost | (counterclockwise |
| | of radii | spirals | hub¹⁾ | hub | ellipse²⁾ | ellipse³⁾ | from X-axis) |
| Input data | 18 | 7 | 0 | 0 | 10.5 | 8.25 | 0 |

¹⁾If the point of origin is included, then the number of spirals is 8
²⁾The length of the major axis of the outermost ellipse = 23/2 − 1 = 10.5
³⁾The length of the minor axis of the outermost ellipse = 18.5/2 − 1 = 8.25

When the data shown in Table 12 are input into the computer programming of spider web that uses ellipse functions, elliptical spider web like that in FIG. 26 is modeled.

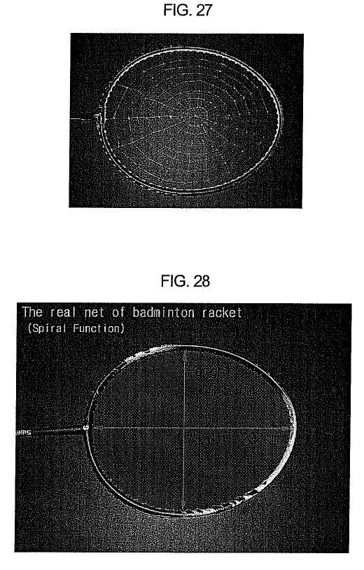

FIG. 27 is an actual application case of modeled spider web in FIG. 26 to the net of the badminton racket shown in FIG. 25.

FIG. 28 is a picture of a badminton racket to which computer modeling of spiral spider web will be applied. The head of the badminton racket illustrated in FIG. 28 is 23 cm in width and 18.5 in height. Based on the size of the badminton racket, Table 13 shows the possible input data to model spider webs.

TABLE 13

| | | direction of | | vertical | | slope of spiral |
|---|---|---|---|---|---|---|
| | number | winding(clock: 1, | horizontal | expansion | number | (counterclockwise |
| | of radii | counterclock: 2) | expansion rate | rate | of spirals | from x-axis) |
| Input data | 18 | 2 | 0.23874 | 0.18759 | 7 | 0.0 |

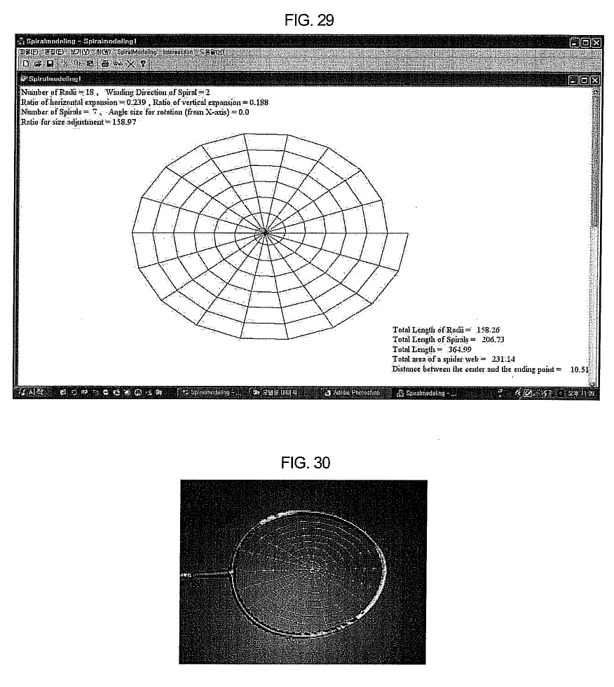

When the data shown in Table 13 are input into the computer programming of spider web that uses spiral function, spider web like that in FIG. 29 is modeled.

FIG. 30 is an actual application case of modeled spider web in FIG. 29 to the net of the badminton racket shown in FIG. 28.

Thus, badminton rackets produced by following the methods of the embodiment of the present invention (by using the spider web) proved to be more elastic and robust than common badminton rackets.

The embodiment of the present invention offers a method of modeling spider web structures through mathematical approach, modeling elliptical spider webs by connecting the intersections between radii and ellipses and modeling spiral spider webs by connecting the intersections between radii and spirals.

By modeling spider webs through computer programming that is based upon the induced functions, the embodiment of the present invention allows the user to model any kind of orb-webs regardless of their shape and size.

Besides, the embodiment of the present invention can be used for practical application of stable and elastic spider web structures by applying the modeled spider webs to various fields such as safety nets, tennis and badminton rackets, foundation for large buildings, road designs, and sports facilities.

What is claimed is:

1. A method of modeling elliptical spider webs using computer programming, the method comprising:
inputting 7 variables into computer program to model spider webs, including the number of radii, the number of spirals, the length of the major and minor axes of hub, the length of the major and minor axes of outermost ellipse, and the slope of the major axis (counterclockwise from X-axis);
calculating the functions of each radius and the functions of each ellipse according to the number of radii and the number of spirals input based on the 7 variables;
calculating the intersections (X, Y) of each radius and each ellipse by using the radial functions and ellipse functions; and
modeling spider webs by connecting the intersections of each radius to draw radii and by connecting the intersections of each elliptical spiral to draw spirals, based on the intersections.

2. The method of claim 1, further comprising after modeling spider webs, calculating the total length of radii, the total length of spirals, and the total area of a spider web.

3. A method of modeling spiral spider webs using computer programming, the method comprising:
inputting 6 variables into computer program to model spider webs, including the number of radii, the number of spirals, the winding direction of spirals, the ratio of vertical expansion, the ratio of horizontal expansion, and the angle size for rotation (counterclockwise from X-axis);
calculating the functions of radii and the function of spiral (in parametric equation) according to the number of radii and the number of spirals input based on the 6 variables;
calculating the intersections (X, Y) of each radius and each spiral by using the radial functions and spiral function; and
modeling spider webs by connecting the intersections of each radius to draw radii and the intersections of each spiral expressed in spiral function (parametric equation) to draw spirals, based on the intersections.

4. The method of claim 3, further comprising after modeling spider webs, calculating the total length of radii, the total length of spirals, the total area of a spider web, and the distance between the starting and the ending point of the spiral.
